(19) United States
(12) Patent Application Publication
(10) Pub. No.: US 2007/0184409 A1
(43) Pub. Date: Aug. 9, 2007

(54) Dental restoration piece and a method for producing a dental restoration piece

(76) Inventor: Hans-Peter Foser, Balzers (LI)

Correspondence Address: John C. Thompson, 69 Grayton Road, Tonawanda, NY, 14150, US

(21) Appl. No.: 11/657,267

(22) Filed: Jan. 24, 2007

Related U.S. Application Data
(63) Continuation-in-part of application No. 10/762,686, filed on Jan. 22, 2004, now abandoned.

(30) Foreign Application Priority Data
Jan. 22, 2004 (DE) P 103 48 370.5

(51) Int. Cl. A61C 13/08

(52) U.S. Cl. 433/197; 433/202.1

(57) ABSTRACT

A dental restoration piece is provided which includes a base structure and an over structure which at least partially covers the base structure and which includes hardened bite elements. An interconnecting material interconnects the hardened bite elements with the base structure. In accordance with the inventive method of producing a dental restoration piece, the interconnecting material applied onto the base structure is hardened fully after the hardened bite elements have first been pressed into the still-malleable interconnecting material.

### CROSS-REFERENCE TO RELATED APPLICATIONS

This application claims foreign priority benefits under 35 U.S.C. §119(a)-(d) from German patent application ser. no. P 103 48 370.5 filed Oct. 17, 2003. In addition, this application claims priority from U.S. application Ser. No. 10/762,686 filed Jan. 22, 2004, now abandoned.

### TECHNICAL FIELD

The present invention relates to a dental restoration piece and a method for producing a dental restoration piece.

### BACKGROUND OF THE INVENTION

A known dental restoration piece is disclosed in DE 41 33 690. In connection with this known dental restoration piece, plastic finished partial crowns and bite surfaces are used, which are applied as an integral entirety onto the base structure. After the application of these components (which may be referred to as “over structure”) onto the base structure, the plastic semi-finished component of the over structure is hardened via irradiation with ultraviolet, or UV, light, so that a corrected bite surface is thus made available. Such bite surfaces are comparatively soft. At the same time, intensive hand finishing work of such bite surfaces is required to configure the bite surfaces into configurations which simulate the dental structures which are to be restored and the dental restoration piece which is produced by this approach is heavily dependent upon the capability of the dentist or, as the occasion may be, upon the capability of the dental technician, to produce the desired tooth protuberance shape.

Moreover, finished elements for the production of dental restoration pieces are already known as is disclosed, for example, in U.S. Pat. No. 6,250,926. The approach disclosed in this publication is suitable for the creation of a dental restoration piece, which is configured by covering a metal frame with an opaque covering and thereafter applying thereon a layer of dentin material ceramic. The dental restoration piece precisely establishes the shape of incisal surfaces. The ceramic layer, or coating, which is configured in approximation of the dentin, must have an exact shape so that no orientation errors can arise. Via the application of two layers or coatings, an aesthetic corresponding result can be achieved; however, a decidedly precise handling of the piece is required in order to assuredly prevent the creation of dental positioning errors.

### OBJECTS AND SUMMARY OF THE INVENTION

The present invention offers a solution to the challenge of providing a dental restoration piece, as well as a method of producing a dental restoration piece, which permits a flexible delivery of dental service via rapid production of the dental restoration piece without posing special hand finishing requirements.

In accordance with the present invention, it is particularly advantageous that at least one bite element—and even more preferably, two bite elements—are made ready as pre-prepared elements as a consequence of which the tooth protuberance shapes can be pre-finished via an industrial process and, thus, to this extent, these tooth protuberance shapes are produced as optimum shapes without manual intervention by a dentist or dental technician.

In this manner, the time for producing an individual optimized bite surface can be significantly reduced and, as well, the dental restoration piece result provides an improved configuration. The dentist need only, after placement of the teeth, for example, in an articulator, work or handle the interconnecting material such that the interconnecting material extends to and communicates in a flush manner with the edges of the bite surface element or the bite surface elements. It is to be understood that, via the making ready of different bite surface elements, different teeth or tooth shapes can be realized as well. For example, a relatively pronounced convex shape of the bite surface elements typically creates a large intercoronary free space, i.e.—the space between the teeth in the occlusal state.

In accordance with the present invention, it is particularly advantageous that, via the embedding of the bite element in the interconnecting material which is disposed in opposition to the bite element, the advantages of ceramic crowns and plastic crowns are combined: the elastic positioning of the bite element reduces the load on the antagonistic teeth (the teeth in biting opposition to the restoration teeth) while, due to the hardened bite surface, the wear is reduced.

In accordance with the present invention, the interconnecting material can be hardened in place in a surprisingly simple manner. It is possible to undertake a thermal hardening for those regions of the interconnecting material, if they are composed of plastic, provided that they are covered by the bite elements so that the interconnecting material is not polymerized via light irradiation.

While, as a basic consideration, thermal and/or light-hardenable plastics are preferred as the plastic material, a viscous tooth cement can be used in a similar manner, which can be, as the occasion arises, covered as well with a suitable protective layer comprised of, for example, plastic as well.

Surprisingly, in spite of the use of two or three different materials with different heat expansion coefficients, no edge cracks arise. In accordance with the present invention, it is particularly advantageous that the time-consuming firing of the over structure is not required, which permits the cycle time for the production of a dental restoration piece in a dental laboratory to be substantially reduced.

In this connection, it is also advantageous that a dental restoration piece produced in accordance with the present invention can also be polished to a high degree whereby, as well, the transition between the interconnecting material and the bite element can be made ready in a gap-free or crack-free manner.

In accordance with the present invention, it is furthermore advantageous that the relatively soft embedding of the bite element in the soft interconnecting material disposed in opposition to the bite elements significantly reduces the occurrence of fatigue breaks of the hardened bite elements even if, in fact, particularly hard plastic for the bite elements is used or a hard ceramic is used for the bite element.

In accordance with the present invention, it is additionally particularly advantageous that the bite element, which can form a partial bite surface, can be configured in a pre-prepared manner so that a particularly good outer surface quality can be realized.

In accordance with the present invention, it is also possible to use oxide ceramic as well as zirconium oxide for the bite elements which, due to their hardness, would otherwise damage the antagonistic teeth elements but, in accordance with the present invention, do not produce such damage due to the soft embedding of the bite elements.

It is to be understood that the number of bite elements can be adapted in a desired manner to the respective requirements. For example, bisected bite surfaces can be provided for the pre-molars—that is, two bite elements can be applied onto the interconnecting material—while, for the molars, three or four bite elements can be deployed in correspondence with the number of tooth protuberances.

It is particularly advantageous that the tooth protuberance slope can be individually adjustably set. In this manner, the desired occlusion outcome can be optimally set and can be set in a precise manner.

In an advantageous embodiment of the invention, intermediate members can be industrially pre-fabricated and can be anchored in a relatively soft manner via the inventive interconnecting material.

Initially, the required preparation is undertaken for the production of an inventive dental restoration piece. The base structure is formed into a finished condition such as, for example, with a metal coating or formed of complete ceramic or formed in another suitable desired manner. A model is molded of gypsum in a conventional manner. An interconnecting material is applied onto the base structure and, in fact, is comprised of a viscosity which still permits deformation while, however, not permitting deformation of the interconnecting material due solely to the force of gravity. The bite elements are now applied in correspondence with the bite situation and are justified or adjusted in the articulator. In this connection, they are pressed into the interconnecting material mass whereby a fine or precise adjustment can be undertaken.

The hardening of the thus-produced dental restoration piece into its final hardened condition fixes it into its position. The fixing of the dental restoration piece into its position can also be effected by a breaking down of a selected component via a silicone break down agent. There remains only a small free play space, in facing disposition to the preparation border, and the free play space is filled with suitable material such as, for example, light-hardenable plastic, and a hardening out of the thus-applied filler material into its complete hardened condition is then undertaken.

In accordance with the present invention, it is preferable to undertake a securement of the base structure onto a tooth stump. In this manner, a long-lasting strong and shape-fitting support can be realized which permits the correspondingly configured pre-prepared preparation to be harmoniously applied thereunto. Alternatively, it is also possible to secure the base structure onto a tooth peg or, as the occasion arises, onto an attachment element which can itself be anchored in a conventional manner.

Further advantages, details, and features are described in the hereinafter following description of an embodiment of the invention having reference to the figures of the drawings.

### BRIEF DESCRIPTION OF THE FIGURES

FIG. 1 is a schematic perspective view of a model of a lower jaw after the preparation thereof to receive an inventive dental restoration piece;

FIG. 2 is a schematic perspective view of one embodiment of the inventive dental restoration piece during the production thereof;

FIG. 3 is a schematic perspective view of a modification of the one embodiment of the inventive dental restoration piece shown in FIG. 2; and

FIG. 4 is a schematic perspective view of a finished frame base structure for one of the dental restoration pieces shown in FIGS. 2 and 3.

FIG. 5 is a partial cross-sectional view of a prepared tooth, such as a molar, which is to receive an inventive dental restoration piece.

FIG. 6 is a partial cross-sectional view of the dental restoration after the base structure has been placed on the prepared tooth shown in FIG. 5.

FIG. 7 is a partial cross-sectional view of the dental restoration after the interconnecting material has been applied and before the bite elements are applied.

FIG. 8 is a partial cross sectional view of the dental restoration after the bite elements have been applied and further showing the application of the silicone breakdown agent.

FIG. 9 shows a finished dental restoration, partially in cross-section.

### DETAILED DESCRIPTION

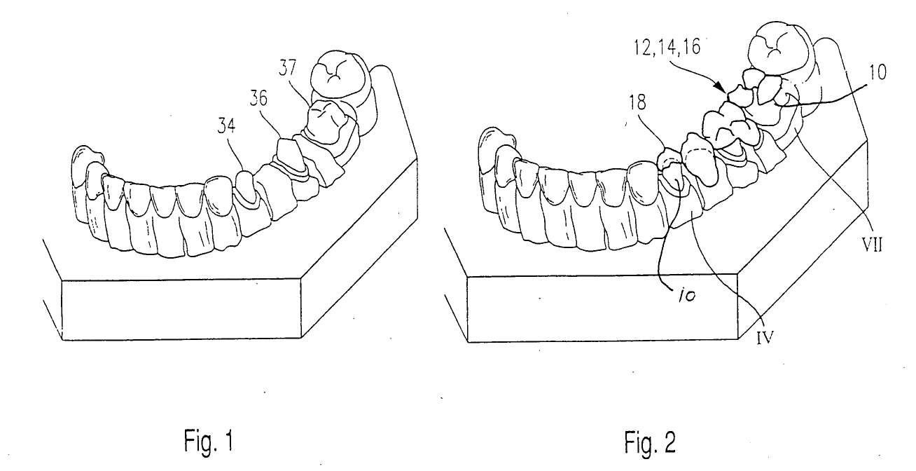

As can be seen in FIG. 1, a dental region which is to be restored—in this example, the lower jaw side tooth region—is initially prepared in a conventional manner whereupon, for example, the tooth posts 34, 36 and 37 remain. A model is prepared in a conventional manner and is preferably prepared out of super hard gypsum. A base structure 13 is created in a conventional manner based upon the model. The base structure serves as a basis for building the dental restoration piece and basically gives the strength to allow mounting of the restoration piece.

Usually, it is fully covered; thus not visible. However, in view of the translucent property of the “over structure”, its color etc. has an influence on the esthetic presentation of the dental restoration piece as well. The base structure can be disposed into an articulator or, alternatively, can be disposed for fitment testing purposes onto the tooth posts.

As can be seen in FIG. 1, a dental region which is to be restored—in this example, the lower jaw side tooth region—is initially prepared in a conventional manner whereupon, for example, the tooth posts 34, 36 and 37 remain. A model is prepared in a conventional manner and is preferably prepared out of super hard gypsum. A base structure 13 is created in a conventional manner based upon the model. The base structure serves as a basis for building the dental restoration piece and basically gives the strength to allow mounting of the restoration piece.

Usually, it is fully covered; thus not visible. However, in view of the translucent property of the “over structure”, its color etc. has an influence on the esthetic presentation of the dental restoration piece as well. The base structure can be disposed into an articulator or, alternatively, can be disposed for fitment testing purposes onto the tooth posts.

In accordance with the present invention, an interconnecting material 10 is applied, as seen in FIG. 2, onto the base structure (not shown in FIG. 2), wherein the interconnecting material already is in substantially the shape of the subsequent dental restoration. The interconnecting material 10, which is applied onto the base structure, is applied in a still-deformable or malleable condition. The inventive bite elements are now pressed into the interconnecting material 10, whereby, as seen in FIG. 2, three bite elements, 12, 14 and 16 are applied onto the tooth VII, and single bite element 18 is applied to the interconnecting material 10 on tooth IV.

The advantage of the inventive solution lies in the fact that fine or precise positioning can be performed, even relative to the opposed model disposed in the articulator;

due to the inventive semi-permanent condition of the mass which is used as the interconnecting material, the desired position can be obtained without further effort or intervention.

It is to be understood that, via the pressing-in of the bite elements 12-16, a spill-over of material occurs. This can be easily removed during or after completion of the restoration or can be removed at a desired time after the pressing-in of the bite elements.

It is particularly advantageous in connection with the inventive solution that the tooth protuberance slope can be individually adjusted in a very fine or precise manner. In this manner, both steep tooth protuberances or flat tooth protuberances can be configured with the same bite surface elements. The inventory requirements for such bite surface elements of the inventive dental restoration piece are thus very small.

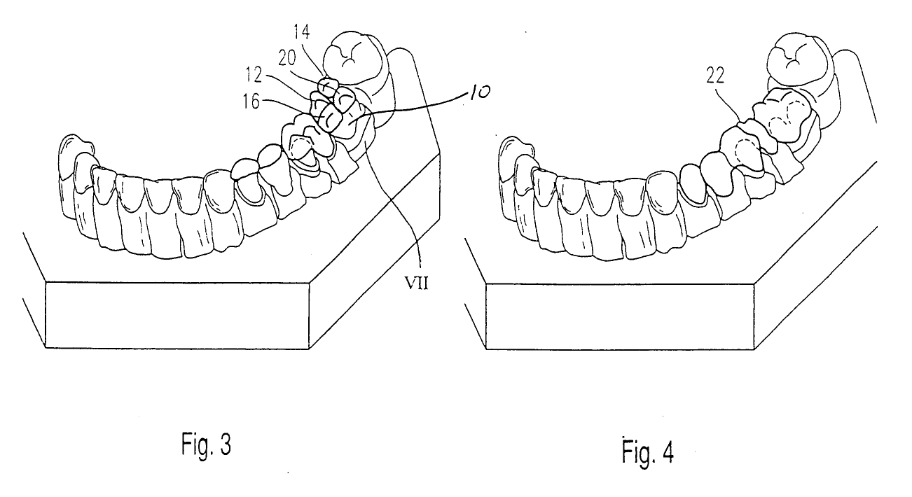

While in the embodiment shown in FIG. 2, a molar VII is provided with the bite elements 12, 14 and 16, a molar VII shown in FIG. 3 is provided with four tooth protuberances 12, 14, 16, and 20—that is, four correspondingly configured bite elements are provided. In this modified embodiment, the positions of the bite elements in-situ are initially maintained via silicone; the assembly of the frame follows thereafter.

It is to be understood that, even if the base structure and over structure must be compatibly configured relative to one another, a certain parallelism is possible in connection with their production, which further saves time. The production of the frame for the base structure can be seen in FIG. 4. In this embodiment, the bite surface elements are fixedly mounted in an operation involving the silicone break down agent 22 and the securement onto the tooth posts then follows with light-hardenable plastic being applied in a conventional manner to extend up to the preparation borders.

FIG. 5 depicts a schematic prepared tooth 36 in partial cross-sectional view. The wire 21 is inserted in the gap neck of the tooth and the gum.

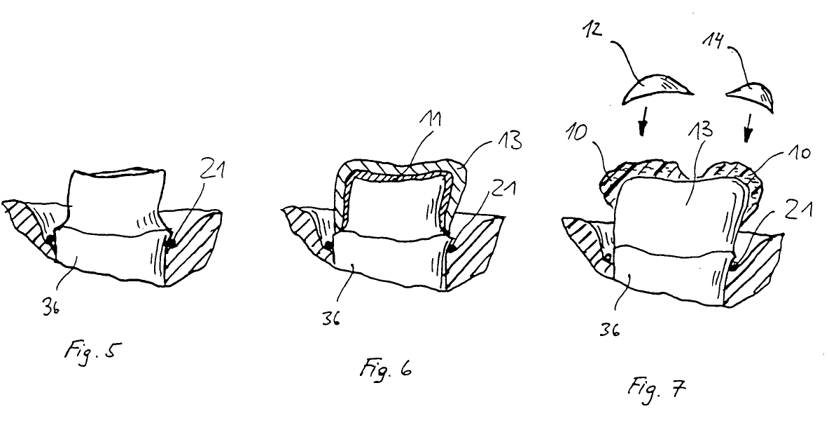

FIG. 6 shows how the base structure 13 is fixed to the prepared tooth using a cement 11.

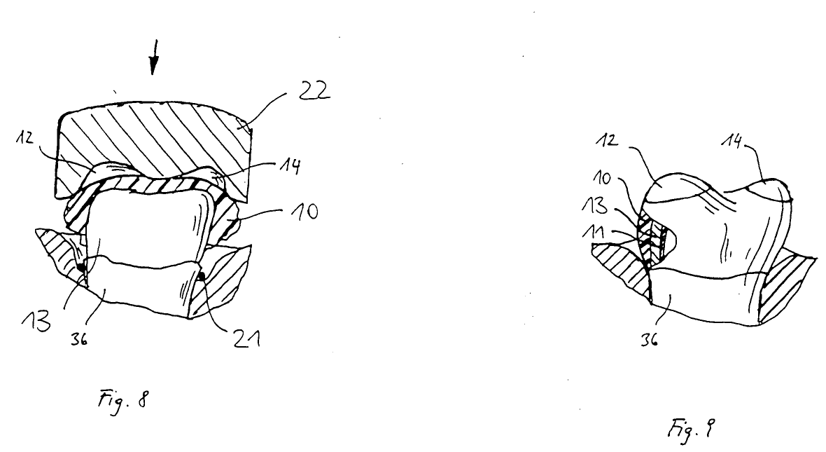

FIG. 7 shows the placing of two hardened bite elements 12, 14 according to one advantageous embodiment of the present invention. The interconnecting material 10 is first applied to the base structure 13, and afterwards the two hardened bite elements 12, 14 are pressed into the soft interconnecting material 10.

In FIG. 8 a silicone breakdown agent 22 is used to form the complete overstructure comprising the interconnecting material 10 and two hardened bite elements 12, 14 by adjusting the position of the two hardened bite elements 12, 14 and by forming the desired shape of the interconnecting material.

FIG. 9 depicts the result of the dental restoration according to one advantageous embodiment of the present invention. Wire 21 has been removed as well as the overspill of the interconnecting material 10.

It is to be understood that, as well, a self-hardening plastic can be deployed.

It is further to be understood that the inventive combination of hardened bite surface elements and a soft interconnecting material disposed relative thereto does not foreclose the possibility that additional soft or hard material can be deployed. Thus, for example, a ceramic base structure piece can be connected via teeth cement with another ceramic base structure piece in a conventional manner. The inventive bite surface elements are not limited in this example to an oxide ceramic; it is much more the case that, in lieu thereof, a pre-finished and hardened adjustable plastic can be deployed.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A dental restoration piece, comprising
a base structure (13);
an over structure (12, 14, 16, 18, 20) which is securable to the base structure in a manner in which the over structure at least partially covers the base structure, the over structure being comprised of at least two hardened bite elements; and
interconnecting material (10) which secures the hardened bite elements to the base structure.

2. A dental restoration piece according to claim 1, wherein the interconnecting material is comprised of ceramic.

3. A dental restoration piece according to claim 1, wherein at least one of the bite elements is comprised of a pre-prepared ceramic.

4. A dental restoration piece according to claim 1, wherein a bite element is comprised of a pre-prepared plastic element.

5. A dental restoration piece according to claim 1, wherein the base structure comprises a selected one of a metal frame, a metal ceramic frame, a ceramic frame, a plastic frame, and a plastic fiberglass frame.

6. A dental restoration piece according to claim 1, wherein each bite element forms a partial bite surface and, the bite surface for each individual tooth, consists of two, three, or four individual bite elements which are applied onto positions corresponding to the tooth protuberance locations of the respective tooth and the dental restoration piece is specifically configured for a pre-molar or a molar.

7. A method for producing a dental restoration piece, comprising the steps of:
providing a base structure;
applying an interconnecting material onto a base structure;
pressing onto the interconnecting material at least two hardened bite elements which forms at least a portion of the bite forming region of the over surface in a manner such that the hardened bite elements are ultimately oriented for biting operation; and
subjecting the interconnecting material on the base structure to a hardening process by which the interconnecting material is hardened fully.
